(19) United States
(12) Patent Application Publication
(10) Pub. No.: US 2010/0076601 A1
(43) Pub. Date: Mar. 25, 2010

(54) FROG-LEG-ARM ROBOT AND CONTROL METHOD THEREOF

(76) Inventors: Kengo Matsuo, Yokohama-shi (JP); Hiroaki Imaizumi, Kawasaki-shi (JP); Akio Ueda, Yokohama-shi (JP); Ichiro Yasuzumi, Yokohama-shi (JP); Hiroki Murakami, Yokohama-shi (JP); Hiroyuki Amada, Yokohama-shi (JP)

Correspondence Address: OSTROLENK FABER GERB & SOFFEN, 1180 AVENUE OF THE AMERICAS, NEW YORK, NY, 100368403, US

(21) Appl. No.: 12/447,784

(22) PCT Filed: Nov. 9, 2007
(86) PCT No.: PCT/JP2007/071791

§ 371 Date: Apr. 29, 2009

(30) Foreign Application Priority Data
Nov. 9, 2006 (JP) 2006-304002
Mar. 29, 2007 (JP) 2007-086492
Mar. 29, 2007 (JP) 2007-086493

(51) Int. Cl. B25J 9/06

(52) U.S. Cl. 700/261

(57) ABSTRACT

The frog-leg-arm robot is provided with a torque motor connected to a wrist rotation shaft to supply torque to a rotation shaft to which the torque motor itself is connected and a control unit in which, when each of arms constituting the frog-leg-arm robot is able to shift from the present posture to any plurality of postures including a targeted posture by a driving device, the torque motor is electrically controlled so that the torque is supplied to the wrist rotation shaft in a direction in which each of the arms is able to shift to the targeted posture.

The application concerned is claims priority from Patent Application No. 2006-304002 filed on Nov. 9, 2006, Patent Application No. 2007-86492 filed on Mar. 29, 2007, and Patent Application No. 2007-86493 filed on Mar. 29, 2007, with the content cited herewith.

### TECHNICAL FIELD

The present invention relates to a frog-leg-arm robot for transferring an object to be conveyed, with the object placed on a hand unit, and also to a control method thereof.

### BACKGROUND ART OF THE INVENTION

There have conventionally been used arm robots for transferring a certain object to be conveyed, with the object placed on a hand unit. Among some of these arm robots, there is provided a so-called frog-leg-arm robot in which a hand unit is supported by two arms which move in synchronization.

Each of the arms of the frog-leg-arm robot is constituted with an upper arm and a forearm coupled by a rotation shaft, and the upper arm of each arm is rotated and driven by a driving motor mounted on the main body, thereby moving the hand unit coupled to the forearm.

Incidentally, in a frog-leg-arm robot, there is a case that when an arm is in a predetermined posture, the arm is driven by a driving motor into a state to shift from the present posture to any plurality of postures including a targeted posture. This state is a so-called singular point. When the robot at the singular point is driven by the driving motor, it becomes uncertain whether the arm will shift to the targeted posture or to an untargeted posture, and therefore, control of the robot becomes unstable. On passing through the singular point, the arm is ordinarily able to shift to the targeted posture without halting at the singular point, because the arm moves at a certain speed. However, in the event that the arm halts at the singular point, the robot will be made uncontrollable.

With the above difficulty taken into account, for example, Patent Document 1 has described a frog-leg-arm robot having sprockets and chains in order to transfer the power of a driving motor to a rotation shaft which couples an upper arm to a forearm for rotation. According to the frog-leg-arm robot having these sprockets and chains, torque is supplied via chains or the like to the rotation shaft which couples the upper arm with the forearm, thereby a singular point of control is eliminated.

Furthermore, Patent Document 2 has described a frog-leg-arm robot which is provided with a spring member mounted on a forearm in the vicinity of a part coupling an upper arm with the forearm and a reaction receiver leading to a component to which the forearm is connected so that torque is supplied in the neighborhood of a singular point. According to the frog-leg-arm robot having the spring member and the reaction receiver, an urging force resulting from the spring member can be used to eliminate a singular point of control.

Still furthermore, Patent Document 3 has described an example where a link member is further provided, thus an attempt is made to eliminate the singular point.

In addition, Patent Document 4 has disclosed an example where a singular point of a flat link mechanism is as an action by which the motion of a frog-leg-arm robot is fixed, and an air cylinder and a rack and pinion are used to eliminate the action.

Patent Document 1: Japanese Unexamined Patent Application, First Publication No. H11-216691
Patent Document 2: Japanese Unexamined Patent Application, First Publication No. H02-311237

### Patent Document 3: Japanese Unexamined Patent Application, First Publication No. 2000-42970

### Patent Document 4: Japanese Patent No. 3682861

### DETAILED DESCRIPTION OF THE INVENTION

### Problems to be Solved by the Invention

However, where a mechanical mechanism such as sprockets and chains is used to supply torque to a rotation shaft, there is a difference in installation accuracy and configuration accuracy. Thus, it is impossible to completely eliminate a singular point of control.

For example, when chains are loosened in tension, no torque is supplied to the rotation shaft which couples an upper arm with a forearm, thereby generating the singular point of control. For this reason, when an arm halts at the singular point or moves to the targeted posture from the singular point, there are found defects such as unstable motions of the robot.

Use of a spring member and a reaction receiver is reliably effective in eliminating the singular point. However, since the behavior of the forearm (i.e. load) depends on a spring force in the neighborhood of the singular point, it is necessary to adjust the spring force so as to meet the operation speed and weight of the load. If the spring force is not properly adjusted, the load may be subjected to impact in the vicinity of the singular point or the speed may be extremely increased only in the vicinity of the singular point. Thereby, it is difficult for the robot to move smoothly. In order to cope with this difficulty, it is necessary to exchange the spring members or the reaction receivers. Specifically, there is such a defect that the robot is vulnerable to change in an operation environment.

Where the link member is further provided, the singular point can be eliminated from the standpoint of the mechanism. However, the robot becomes complicated in structure and may be operated under strict conditions, with consideration given to dimensions, weight, cost and others.

Use of the air cylinder is effective in eliminating the singular point. However, when a cylinder thrust force and others are adjusted in a pneumatic circuit in association with change in operational conditions, the adjustment is easily influenced by pressure loss or the like, depending on the conditions of pneumatic piping. Furthermore, it is necessary to provide an air supply source separately for operating the air cylinder, in addition to a power source for driving arms. Still furthermore, a wider operation range would require the use of a long-stroke cylinder.

As described above, no practical measure has been available for coping with the singular point in a conventional frog-leg-arm robot.

The present invention has been made in view of the above-described difficulties, and an object thereof is to practically eliminate a singular point of control in a frog-leg-arm robot and also to operate the frog-leg-arm robot smoothly.

### Means for Solving the Problems

In order to attain the above object, the frog-leg-arm robot of the present invention includes:

a main body;

a driving device mounted on the main body;

a first upper arm, one end of the first upper arm being coupled to the main body via a first rotation shaft rotated by the driving device and the first upper arm being able to swing along a reference planar surface;

a second upper arm, one end of the second upper arm being coupled to the main body via the first rotation shaft or the other first rotation shaft rotated and driven by the driving device and the second upper arm being able to swing along the reference planar surface;

a first forearm, one end of the first forearm being supported on the other end of the first upper arm so as to rotate via a second rotation shaft and the first forearm being able to swing along the reference planar surface;

a second forearm, one end of the second forearm being supported on the other end of the second upper arm so as to rotate via a third rotation shaft and the second forearm being able to swing along the reference planar surface;

a hand unit which is supported on the other end of the first forearm so as to rotate via a fourth rotation shaft and also supported on the other end of the second forearm so as to rotate via a fifth rotation shaft;

a synchronization device for synchronically rotating the fourth rotation shaft and the fifth rotation shaft in the opposite direction;

a torque motor which is connected to at least one of the second rotation shaft, the third rotation shaft, the fourth rotation shaft and the fifth rotation shaft to supply torque to the rotation shaft to which the torque motor itself is connected; and

a control unit which electrically controls the torque motor in such a manner that when the first upper arm, the second upper arm, the first forearm and the second forearm are able to shift from the current posture to any plurality of postures including a targeted posture by the driving force of the driving device, the torque is supplied to the rotation shaft in a direction which each of the arms is able to shift to the targeted posture.

According to the above-constituted frog-leg-arm robot of the present invention, when the first upper arm, the second upper arm, the first forearm and the second forearm are able to shift from the present posture to any plurality of postures including a targeted posture by the driving force of the driving device. That is, when the robot assumes a posture which is conventionally taken as a singular point, the torque motor is electrically controlled by the control unit. Thereby, torque is supplied to at least one of the second rotation shaft, the third rotation shaft, the fourth rotation shaft and the fifth rotation shaft in a direction in which each of the arms constituting the robot is able to shift to the targeted posture.

In the frog-leg-arm robot of the present invention, the torque supplied by the torque motor to at least one of the second rotation shaft, the third rotation shaft, the fourth rotation shaft and the fifth rotation shaft may be smaller than the torque supplied by the driving device to the first rotation shaft.

In the frog-leg-arm robot of the present invention, the control unit may control the torque motor so that the torque is constantly supplied in the same direction during the movement of the hand unit to a predetermined direction.

In the frog-leg-arm robot of the present invention, the torque motor may be accommodated inside at least one of the first upper arm, the second upper arm, the first forearm and the second forearm.

In the frog-leg-arm robot of the present invention, the torque motor may supply torque based on a torque control signal to a rotation shaft to which the torque motor itself is connected and also may rotate the rotation shaft at a rotational speed based on a rotational-speed control signal. Then, the control unit may input the torque control signal into the torque motor and also may input the rotational-speed control signal into the torque motor so that the rotational speed of the torque motor is synchronized with the rotational speed of the rotation shaft which is rotated dependent on the driving force of the driving device.

According to the frog-leg-arm robot of the present invention, when the torque control signal is input from the control unit into the torque motor, specifically, when torque is supplied to the rotation shaft, the rotational-speed control signal is input together with the torque control signal. The rotational-speed control signal is a signal for controlling the rotational speed of the torque motor so that the rotational speed of the torque motor can be synchronized with the rotational speed of the rotation shaft when the rotation shaft to which the torque motor is connected is rotated dependent on the driving force of the driving motor. Thereby, upon supply of torque to the rotation shaft, the rotational speed of the rotation shaft is synchronized with the rotational speed of the torque motor.

In the present invention, a description that “the rotational speed of the torque motor is synchronized with the rotational speed of the rotation shaft which is rotated dependent on the driving force of the driving motor” means that the rotational speed when the rotation shaft to which the torque motor is connected is rotated dependent on the driving force of the torque motor is substantially in agreement with the rotational speed when the rotation shaft is rotated dependent on the driving force of the driving motor. More specifically, the above description also includes that the rotational speed of the torque motor and that of the rotation shaft are changed with the lapse of time, while the absolute magnitude also kept in synchronization (being changed in strict accordance) and also that both of them are changed with the lapse of time in synchronization, although these are different in absolute magnitude of the rotational speed.

In the frog-leg-arm robot of the present invention, the rotational speed of the first rotation shaft rotated by the driving device is multiplied by a structurally defined certain ratio, thereby the second, the third, the fourth and the fifth rotation shafts are provided for the respective rotational speeds. For example, if the first upper arm is equal in length to the second upper arm, the fourth and the fifth rotation shafts are two times greater in rotational speed than the first rotation shaft. A description of “synchronization” used in the present invention means that the first rotation shaft rotated by the driving device and the rotation shaft rotated by the torque motor are controlled for the rotational speed so as to keep the structurally defined ratio. Still furthermore, the synchronization of the driving motor with the torque motor is determined dependent on the synchronization of the first rotation shaft with the rotation shaft which is rotated by the torque motor.

In the frog-leg-arm robot of the present invention, the control unit may calculate a rotational speed of the rotation shaft to which the torque motor is connected based on a control value of the driving device.

The frog-leg-arm robot of the present invention may be further provided with a reduction gear interposed between the torque motor and the rotation shaft to reduce the rotational speed of the torque motor and transfer the rotation of the torque motor to the rotation shaft. Then, the control unit may generate the rotational-speed control signal based on a reduction ratio of the reduction gear and the rotational speed of the rotation shaft reduced by the reduction gear.

The frog-leg-arm robot of the present invention may be provided with only one torque motor.

In the frog-leg-arm robot of the present invention, the driving device may be provided with a first driving motor for swinging the first upper arm via the first rotation shaft and a second driving motor for swinging the second upper arm via the other first rotation shaft.

In the frog-leg-arm robot of the present invention, the driving device may be provided with a driving motor for swinging the first upper arm via the first rotation shaft and a driving-force transfer mechanism mounted between the first rotation shaft and the second rotation shaft to swing the second upper end by transferring the driving force of the driving motor from the first rotation shaft to the second rotation shaft.

The method for controlling the frog-leg-arm robot of the present invention is a method for controlling a frog-leg-arm robot which is provided with a main body; a driving device mounted on the main body, a first upper arm, one end of the first upper arm being coupled to the main body via a first rotation shaft rotated by the driving device and the first upper arm being able to swing along a reference planar surface, a second upper arm, one end of the second upper arm being coupled to the main body via the first rotation shaft or the other first rotation shaft rotated and driven by the driving device and the second upper arm being able to swing along the reference planar surface, a first forearm, one end of the first forearm being supported on the other end of the first upper arm so as to rotate via a second rotation shaft and the first forearm being able to swing along the reference planar surface, a second forearm, one end of the second forearm being supported on the other end of the second upper arm so as to rotate via a third rotation shaft and the second forearm being able to swing along the reference planar surface, a hand unit which is supported on the other end of the first forearm so as to rotate via a fourth rotation shaft and also supported on the other end of the second forearm so as to rotate via a fifth rotation shaft, a synchronization device for synchronically rotating the fourth rotation shaft and the fifth rotation shaft in the opposite direction, and a torque motor which is connected to at least one of the second rotation shaft, the third rotation shaft, the fourth rotation shaft and the fifth rotation shaft to supply torque to the rotation shaft to which the torque motor itself is connected, and the method for controlling the frog-leg-arm robot includes a step of electrically controlling the torque motor so that the torque is supplied to the rotation shaft in a direction in which each of the arms is able to shift to the targeted posture when the first upper arm, the second upper arm, the first forearm and the second forearm are able to shift from the present posture to any plurality of postures including a targeted posture by the driving force of the driving device.

According to the method for controlling the above-constituted frog-leg-arm robot of the present invention, when the first upper arm, the second upper arm, the first forearm and the second forearm are able to shift from the present posture to any plurality of postures including a targeted posture by the driving force of the driving device, that is, when the robot assumes a posture which is conventionally taken as a singular point, the torque motor is electrically controlled by the control unit. Thereby, torque is supplied to at least one of the second, the third, the fourth and the fifth rotation shafts in a direction in which each of the arms constituting the robot is able to shift to a targeted posture.

In the method for controlling the frog-leg-arm robot of the present invention, the torque which is supplied by the torque motor to at least one of the second, the third, the fourth and the fifth rotation shafts may be smaller than the torque supplied by the driving device to the first rotation shaft.

In the method for controlling the frog-leg-arm robot of the present invention, the torque may be constantly supplied in the same direction, during the movement of the hand unit to a predetermined one direction.

In the method for controlling the frog-leg-arm robot of the present invention, the torque motor may supply torque based on a torque control signal to the rotation shaft to which the torque motor itself is connected and also may rotate the rotation shaft at a rotational speed based on a rotational-speed control signal. Then, the torque control signal is input into the torque motor and the rotational-speed control signal may be input into the torque motor in such a manner that the rotational speed of the torque motor is synchronized with the rotational speed of the rotation shaft which is rotated dependent on the driving force of the driving device.

According to the method for controlling the frog-leg-arm robot of the present invention, when the torque control signal is input into the torque motor, that is, when torque is supplied to the rotation shaft to which the torque motor is connected, the rotational-speed control signal is input into the torque motor, together with the torque control signal. The rotational-speed control signal is a signal for controlling the rotational speed of the torque motor so that the rotational speed of the torque motor can be synchronized with the rotational speed of the rotation shaft when the rotation shaft to which the torque motor is connected is rotated dependent on the driving force of the driving motor. Thereby, upon supply of the torque to the rotation shaft, the rotational speed of the rotation shaft is synchronized with the rotational speed of the torque motor.

In the method for controlling the frog-leg-arm robot of the present invention, the rotational speed of the rotation shaft to which the torque motor is connected may be calculated based on a control value of the driving device.

In the method for controlling the frog-leg-arm robot of the present invention, the rotational-speed control signal may be generated based on a reduction ratio of a reduction gear interposed between the torque motor and the rotation shaft to reduce the rotational speed of the torque motor and transfer the rotation of the torque motor to the rotation shaft and a rotational speed of the rotation shaft reduced by the reduction gear.

In the method for controlling the frog-leg-arm robot of the present invention, the torque may be supplied to at least one of the second, the third, the fourth and the fifth rotation shafts.

### ADVANTAGEOUS EFFECTS OF THE INVENTION

According to the frog-leg-arm robot of the present invention and the method for controlling the robot, when the robot assumes a posture which is conventionally taken as a singular point, that is, when the first upper arm, the second upper arm, the first forearm and the second forearm are able to shift from the present posture to any plurality of postures including a targeted posture by the driving force of the driving device, the torque motor is electrically controlled to supply torque to at least one of the second, the third, the fourth and the fifth rotation shafts in a direction in which each of the arms constituting the robot is able to shift to the targeted posture. Specifically, in the present invention, the torque can be supplied to the rotation shaft only by electrical control not by mechanical control which depends on the installation accuracy and configuration accuracy.

According to the present invention, the change in operation environment of the frog-leg-arm robot will not result in exchange of mechanical auxiliary device (spring member) such as a leaf spring. In other words, it is possible to adjust a torque amount of the torque motor or others only by changing electrical instructions. It is, thereby, possible to smoothly operate the frog-leg-arm robot in the vicinity of a singular point.

Furthermore, since no addition of link members is required, the frog-leg-arm robot of the present invention is able to solve problems on the singular point, although the structure thereof is simple.

Still furthermore, as compared with the case where an air cylinder is used, electric torque-supply device such as an electric motor is used, it thus becomes possible to stably generate a desired torque without substantially depending on an electrical wiring state. Since the same power source as that used in a driving motor is used, it is possible to eliminate the necessity for separately providing an apparatus such as an air supply source. There is no need for using long components such as a rack-and-pinion gear and an air cylinder, dimensional matters are loosely restricted.

As described above, in a posture which is conventionally taken as a singular point, an electrically-controllable torque motor is used in at least one of the second, the third, the fourth and the fifth rotation shafts to supply torque in a direction in which a frog-leg-arm robot is able to shift to a targeted posture. It is, thereby, possible to practically eliminate a singular point of control in the robot.

According to the frog-leg-arm robot of the present invention and the method for controlling the robot, upon supply of torque to rotation shafts, the rotational speed of the torque motor is synchronized with the rotational speed of the rotation shaft concerned when the rotation shaft to which the torque motor is connected is rotated dependent on the driving force of the driving motor. Specifically, the rotational speed of the rotation shaft to which the torque motor is connected when rotated dependent on the driving force of the torque motor is substantially in agreement with the rotational speed of the rotation shaft concerned when rotated dependent on the driving force of the driving motor. Thereby, no loads are applied to the torque motor or the rotation shaft, if not needed. As a result, it is possible not only to smoothly operate the frog-leg-arm robot in the vicinity of a singular point but also to prevent vibrations to the frog-leg-arm robot resulting from the fact that the rotational speed of the rotation shaft is not in agreement with the rotational speed of the torque motor.

### BRIEF DESCRIPTION OF THE DRAWINGS

FIG. 1 is a plan view showing a first embodiment of the frog-leg-arm robot of the present invention;

FIG. 2 is a side elevational view of the first embodiment of the frog-leg-arm robot of the present invention;

FIG. 3 is a functional block diagram showing the first embodiment of the frog-leg-arm robot of the present invention;

FIG. 4 is a plan view for explaining a special posture of the first embodiment of the frog-leg-arm robot of the present invention;

FIG. 5 is a plan view for explaining a targeted posture of the first embodiment of the frog-leg-arm robot of the present invention;

FIG. 6 is a plan view for explaining an untargeted posture of the first embodiment of the frog-leg-arm robot of the present invention;

FIG. 7 is a side elevational view showing a second embodiment of the frog-leg-arm robot of the present invention;

FIG. 8 is a side elevational view showing a third embodiment of the frog-leg-arm robot of the present invention;

FIG. 9 is a graph for explaining an example of the third embodiment of the frog-leg-arm robot of the present invention or the graph showing the over-time change in rotational speed of one driving motor;

FIG. 10 is a graph for explaining an example of the third embodiment of the frog-leg-arm robot of the present invention or the graph showing the over-time change in torque generated by one driving motor;

FIG. 11 is a graph for explaining an example of the third embodiment of the frog-leg-arm robot of the present invention or the graph showing the over-time change in rotational speed of a shoulder rotation shaft to which one driving motor is connected;

FIG. 12 is a graph for explaining an example of the third embodiment of the frog-leg-arm robot of the present invention or the graph showing the over-time change in rotational speed of the other driving motor;

FIG. 13 is a graph for explaining an example of the third embodiment of the frog-leg-arm robot of the present invention or the graph showing the over-time change in torque generated by the other driving motor;

FIG. 14 is a graph for explaining an example of the third embodiment of the frog-leg-arm robot in the present invention or the graph showing the over-time change in rotational speed of a shoulder rotation shaft to which the other driving motor is connected;

FIG. 15 is a graph for explaining an example of the third embodiment of the frog-leg-arm robot in the present invention or the graph showing the over-time change in rotational speed of a wrist rotation shaft which is rotated dependent on the driving force of the driving device;

FIG. 16 is a graph for explaining an example of the third embodiment of the frog-leg-arm robot in the present invention or the graph showing the over-time change in rotational speed of the torque motor;

FIG. 17 is a graph for explaining an example of the third embodiment of the frog-leg-arm robot in the present invention and the graph showing the over-time change in torque generated by the torque motor; and

FIG. 18 is a plan view showing a modified example applicable to any of the first, the second and the third embodiments of the frog-leg-arm robot in the present invention.

### DESCRIPTION OF REFERENCE SYMBOLS

R FROG-LEG-ARM ROBOT
1 MAIN BODY
2 ARM
11 REDUCTION GEAR
21 ARM (FIRST ARM)
22 ARM (SECOND ARM)
23 UPPER ARM (FIRST UPPER ARM)
24 FOREARM (FIRST FOREARM)
25 UPPER ARM (FIRST UPPER ARM)
26 FOREARM (SECOND FOREARM)
3 HAND UNIT
4 CONTROL UNIT
5 DRIVING DEVICE
51, 52 DRIVING MOTORS
53 REDUCTION GEAR
6A SHOULDER ROTATION SHAFT (FIRST ROTATION SHAFT)
6B ELBOW ROTATION SHAFT (SECOND ROTATION SHAFT)
6C SHOULDER ROTATION SHAFT (FIRST ROTATION SHAFT)
6D ELBOW ROTATION SHAFT (THIRD ROTATION SHAFT)
6E WRIST ROTATION SHAFT (FOURTH ROTATION SHAFT)
6F WRIST ROTATION SHAFT (FIFTH ROTATION SHAFT)
10 TORQUE MOTOR
71, 72 SYNCHRONIZATION GEARS (SYNCHRONIZATION DEVICE)

### BEST MODE FOR CARRYING OUT THE INVENTION

Hereinafter, a description will be given for one embodiment of the frog-leg-arm robot of the present invention and that of the method for controlling the robot with reference to the drawings. It is noted that in the following drawings, each member is changed in scale size appropriately so that it may be of a recognizable size.

### First Embodiment

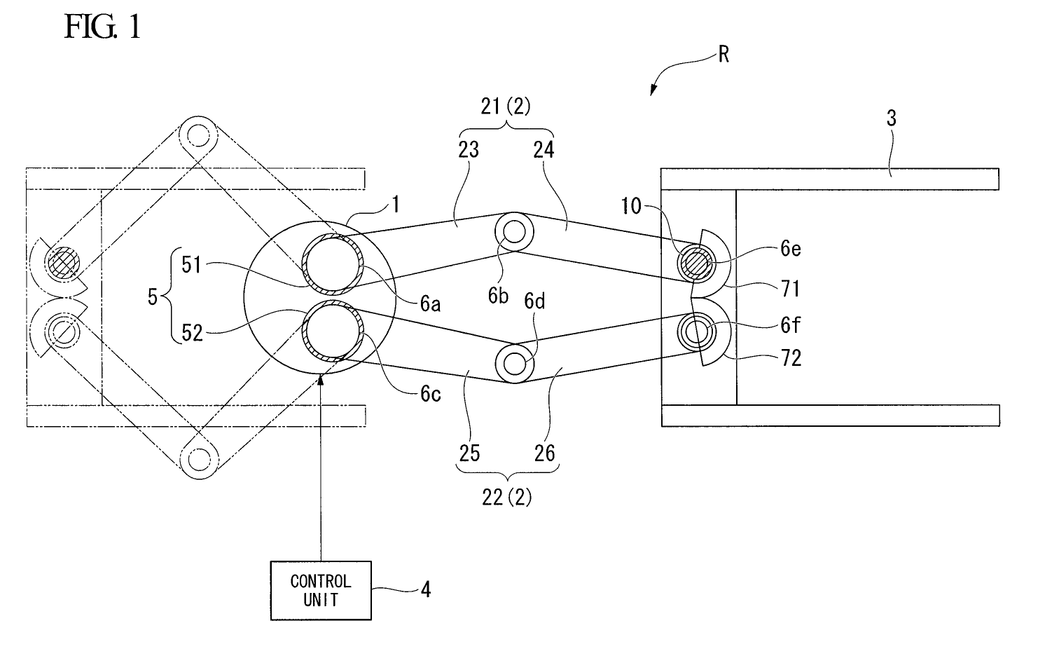

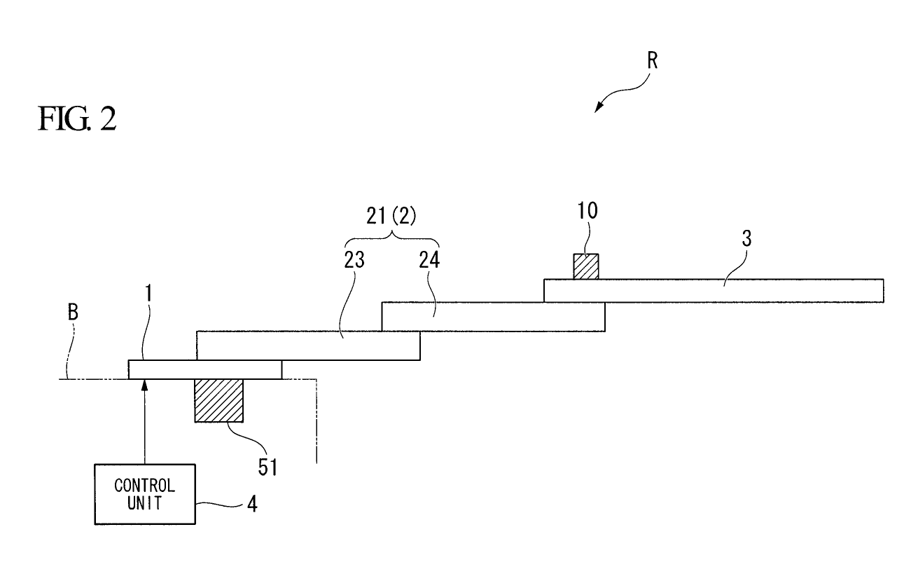

FIG. 1 is a plan view showing a brief constitution of a frog-leg-arm robot R, which is one embodiment of the present invention. FIG. 2 is a side elevational view showing a brief constitution of the frog-leg-arm robot R, which is one embodiment of the present invention. FIG. 3 is a block diagram showing a functional constitution of the frog-leg-arm robot R, which is one embodiment of the present invention.

As shown in these drawings, the frog-leg-arm robot R of the present embodiment is provided with a main body 1, an arm 2, a hand unit 3 and a control unit 4.

The main body 1 is mounted on a base B such as a cage of a stacker crane so as to rotate freely. The main body 1 is provided with a driving device 5 which swings the respective arms 2, thereby moving the hand unit 3 along a horizontal surface (reference planar surface) in the back and forth direction. The driving device 5 is provided with driving motors 51, 52. The driving motor 51 is connected to a shoulder rotation shaft 6a (first rotation shaft), while the driving motor 52 is connected to a shoulder rotation shaft 6c (first rotation shaft).

The arm 2 is constituted with a pair of arms 21, 22 arranged so as to be symmetrical behind a movement range of the hand unit 3. It is noted that in the following description, the arm 21 is referred to as a first arm 21 and the arm 22 is referred to as a second arm 22.

The first arm 21 is constituted with an upper arm 23 (first upper arm) and a forearm 24 (first forearm). One end of the upper arm 23 is coupled to the driving motor 51 mounted on the main body 1 via the shoulder rotation shaft 6a. The upper arm 23 is able to swing along the horizontal surface by being rotated and driven by the driving motor 51. One end of the forearm 24 is supported on the other end of the upper arm 23 so as to rotate freely via an elbow rotation shaft 6b (second rotation shaft). The forearm 24 is able to swing along the horizontal surface by the elbow rotation shaft 6b which is rotated in association with the swing of the upper arm 23.

The second arm 22 is constituted with an upper arm 25 (second upper arm) and a forearm 26 (second forearm). One end of the upper arm 25 is coupled to the driving motor 52 mounted on the main body 1 via a shoulder rotation shaft 6c. The upper arm 25 is able to swing along the horizontal surface by being rotated and driven by the driving motor 52. One end of the forearm 26 is supported on the other end of the upper arm 25 so as to rotate freely via an elbow rotation shaft 6d (third rotation shaft). The forearm 26 is able to swing along the horizontal surface by the elbow rotation shaft 6d which is rotated in association with the swing of the upper arm 25.

The hand unit 3 is supported on the other end of the forearm 24 of the first arm 21 so as to rotate freely via a wrist rotation shaft 6e (fourth rotation shaft) and also supported on the other end of the forearm 26 of the second arm 22 so as to rotate freely via a wrist rotation shaft 6f (fifth rotation shaft). The hand unit 3 is able to place an object to be conveyed (for example, a glass substrate or a cassette which accommodates the glass substrate).

Furthermore, synchronization gears 71, 72 (synchronization device) are provided respectively on the other end of the forearm 24 of the first arm 21 and the other end of the forearm 26 of the second arm 22. The synchronization gears 71, 72 are provided as a pair and one of the synchronization gears 71 is mounted on the other end to the forearm 24, while the other of the synchronization gears 72 is mounted on the other end of the forearm 26. Both of the gears are meshed with each other, by which these can be synchronized and rotated. Thereby, the first arm is synchronized with the second arm 22 and operated symmetrically, thus it becomes possible to move the hand unit 3 linearly.

Then, in the frog-leg-arm robot R of the present embodiment, the torque motor 10 is connected to the wrist rotation shaft 6e which connects the forearm 24 of the first arm 21 with the hand unit 3.

The torque motor 10 is electrically controlled by the control unit 4 to be described later. Specifically, torque based on a torque control signal input from the control unit 4 is supplied to the wrist rotation shaft 6e in a direction along the horizontal surface. A motor which can electrically control the torque is acceptable as the torque motor 10, including a motor such as a servo motor and an induction-type motor.

It is noted that the torque supplied by the torque motor 10 to the wrist rotation shaft 6e is set to be smaller than the torque supplied by the driving motors 51, 52 respectively to the shoulder rotation shafts 6a, 6c. Where motors with an output of 1 kW, for example, are used as the driving motors 51, 52, a motor with an output of 400 to 600 W may be used as the torque motor 10.

The control unit 4 is to control a whole operation of the frog-leg-arm robot R and is provided with a calculation processing unit 41, a storage unit 42, an operation instructing information storage unit 43 and an input output unit 44. The calculation processing unit 41 searches for operation instructing information of the driving motors 51, 52 and the torque motor 10 based on externally input information. The storage unit 42 stores various types of applications and data used by the calculation processing unit 41. The operation instructing information storage unit 43 temporarily stores operation instructing information searched by the calculation processing unit 41. The input output unit 44 inputs and outputs signals between the driving motors 51, 52, the torque motor 10 and the calculation processing unit 41.

The above-constituted control unit 4 drives the driving motor 51 and the driving motor 52 in synchronization, thereby swinging the first arm 21 and the second arm 22 to move the hand unit 3 in the back and forth direction.

Furthermore, if the arm 2 is able to shift from the present posture to any plurality of postures including a targeted posture when only the driving motors 51, 52 are driven, the control unit 4 electrically controls the torque motor 10 and supplies torque to the wrist rotation shaft 6e in an appropriate direction so that the arm 2 is able to shift to the targeted posture.

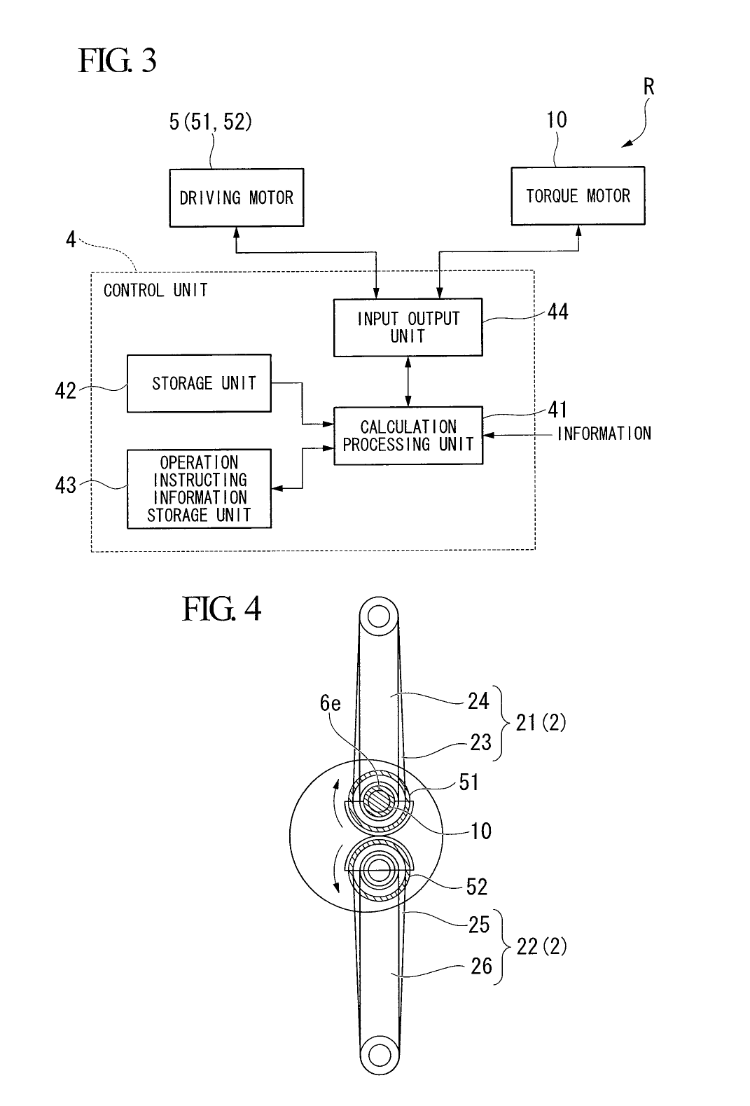

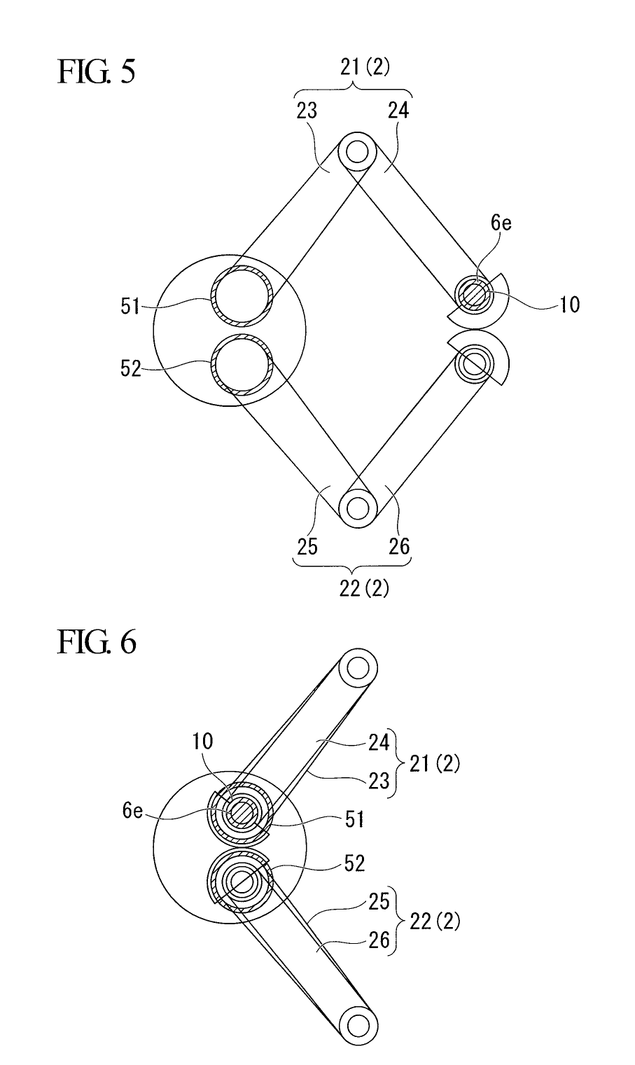

It is noted that a posture in which the arm 2 is able to shift from the present posture to any plurality of postures including a targeted posture is follows. That is, as shown in FIG. 4, such a posture that the upper arm 23 of the first arm 21 is overlapped on the forearm 24, the upper arm 25 of the second arm 22 is overlapped on the forearm 26, and the first arm 21 and the second arm 22 assume a posture as if these were positioned on a certain straight line. In the following description, the posture shown in FIG. 4 is called a special posture. Furthermore, in FIG. 4, FIG. 5 and FIG. 6, the hand unit 3 and the control unit 4 are omitted so that the drawings can be easily recognized.

When the arm 2 assumes the special posture as shown in FIG. 4 and the driving motors 51, 52 are driven in the arrow direction so as to move the hand unit 3 in a push-out direction, there may be a case that the upper arm 23 and the forearm 24 of the first arm 21 are opened to each other, and the upper arm 25 and the forearm 26 of the second arm 22 are also opened to each other, by which the arm 2 shifts to a posture in a direction which pushes out the hand unit 3 as desired (refer to FIG. 5).

On the other hand, there may also be a case where the upper arm 23 of the first arm 21 is overlapped on the forearm 24, the upper arm 25 of the second arm 22 is overlapped on the forearm 26, and, with this state kept, the arm 2 shifts to a posture in a direction which only the first arm 21 and the second arm 22 are rotated, without movement of the hand unit 3 (refer to FIG. 6).

Therefore, when the arm 2 halts in the special posture, it becomes uncertain whether the arm 2 shifts to a targeted posture or to an untargeted posture, therefore, the results in unstable control. In a conventional frog-leg-arm robot, the special posture, that is, the posture which becomes unstable on whether the robot shifts to any plurality of postures including a targeted posture is taken as a singular point of control.

Furthermore, even when the hand unit 3 is moved from the special posture in a drawing direction, the movement of the hand 3 depends on the special posture is given as a singular point of control in the conventional frog-leg-arm robot, as well as when the hand unit 3 is moved in a pushing direction, if depending on the driving of only the driving motors 51, 52.

Next, a description will be given for the operation of the above-constituted frog-leg-arm robot R of the present embodiment (a method for controlling the frog-leg-arm robot).

First, the control unit 4 uses the calculation processing unit 41 to determine a direction at which the hand unit 3 is moved (a push-out or drawing direction) and the amount of the movement thereof based on information on the driving motors 51, 52 and the torque motor 10, information externally input from the frog-leg-arm robot R, applications and data stored at the storage unit 42. In addition, the control unit 4 stores the determined value in the operation instructing information storage unit 43 as operation instructing information.

Then, the control unit 4 draws the operation instructing information from the operation instructing information storage unit 43 at a predetermined timing and inputs an operation instructing signal via the input output unit 44 into the driving motors 51, 52 and the torque motor 10.

For example, when the operation instructing signal which allows the hand unit 3 to move to a predetermined extent in a push-out direction is output from the control unit 4, the driving motor 51 rotates the shoulder rotation shaft 6a clockwise in FIG. 1 and the driving motor 52 rotates the shoulder rotation shaft 6c counterclockwise in FIG. 1.

As described above, the shoulder rotation shaft 6a is rotated clockwise in FIG. 1, by which the upper arm 23 of the first arm 21 is swung in a clockwise direction in FIG. 1, with one end thereof kept at the center. At the same time, the shoulder rotation shaft 6c is rotated in a counterclockwise direction in FIG. 1, by which the upper arm 25 of the second arm 22 is swung in a counterclockwise direction in FIG. 1, with one end thereof kept at the center. The above-described swing of the upper arm 23 is transferred via the elbow rotation shaft 6b to the forearm 24, and the forearm 24 of the first arm 21 is swung in a counterclockwise direction, with the elbow rotation shaft 6b kept at the center. At the same time, the swing of the upper arm 25 is transferred via the elbow rotation shaft 6d to the forearm 26, and the forearm 26 of the second arm 22 is swung in a clockwise direction, with the elbow rotation shaft 6d kept at the center.

In this instance, the movement of the first arm 21 is synchronized with the movement of the second arm 22 by synchronization gears 71, 72 which mesh with each other. Therefore, the swing of the forearm 24 of the first arm 21 is synchronized with the swing of the forearm 26 of the second arm 22.

Then, the swing of the forearm 24 of the first arm 21 is transferred via the wrist rotation shaft 6e to the hand unit 3, and the swing of the forearm 26 of the second arm 22 is transferred via the wrist rotation shaft 6f to the hand unit 3, thereby moving the hand unit 3 in a push-out direction.

Since the movement of the hand unit 3 is determined by the rotational amount of the shoulder rotation shafts 6a, 6c, the driving motors 51, 52 rotate the shoulder rotation shafts 6a, 6c respectively only by the movement of the hand unit 3 to a predetermined extent. Thereby, the hand unit 3 is moved only by the movement to a predetermined extent.

On the other hand, when an operation instructing signal is output from the control unit 4 which allows the hand unit 3 to move to a predetermined extent in a drawing direction, the driving motor 51 rotates the shoulder rotation shaft 6a counterclockwise in FIG. 1, and the driving motor 52 rotates the shoulder rotation shaft 6c clockwise in FIG. 1.

As described above, the shoulder rotation shaft 6a is rotated counterclockwise in FIG. 1, by which the upper arm 23 of the first arm 21 is swung in a counterclockwise direction in FIG. 1, with one end thereof kept at the center. The shoulder rotation shaft 6c is also rotated clockwise in FIG. 1, by which the upper arm 25 of the second arm 22 is swung in a clockwise direction in FIG. 1, with one end thereof kept at the center. The above-described swing of the upper arm 23 is transferred via the elbow rotation shaft 6b to the forearm 24, thereby the forearm 24 of the first arm 21 is swung in a clockwise direction, with the elbow rotation shaft 6b kept at the center. At the same time, the above-described swing of the upper arm 25 is also transferred via the elbow rotation shaft 6d to the forearm 26, and the forearm 26 of the second arm 22 is swung in a counterclockwise direction, with the elbow rotation shaft 6d kept at the center.

Then, the swing of the forearm 24 of the first arm 21 is transferred via the wrist rotation shaft 6e to the hand unit 3, and the swing of the forearm 26 of the second arm 22 is transferred via the wrist rotation shaft 6f to the hand unit 3, thereby moving the hand unit 3 in a drawing direction.

In this instance, in the frog-leg-arm robot R of the present embodiment, during the movement of the hand unit 3, the control unit 4 controls the torque motor 10 to constantly supply torque to the wrist rotation shaft 6e in a direction to shift from the special posture given in FIG. 4 to a targeted posture.

Specifically, where the hand unit 3 is allowed to move in a push-out direction, the control unit 4 electrically controls the torque motor 10 to supply torque to the wrist rotation shaft 6e in a counterclockwise direction in FIG. 1. Furthermore, where the hand unit 3 is allowed to move in a drawing direction, the control unit 4 electrically controls the torque motor 10 to supply torque to the wrist rotation shaft 6e in a clockwise direction in FIG. 1.

Specifically, where the arm 2 assumes the special posture given in FIG. 4 during the movement of the hand unit 3 in a push-out direction, torque is supplied to the wrist rotation shaft 6e in a counterclockwise direction in FIG. 1 (a direction to be available to shift to a targeted posture). Therefore, the arm 2 is able to smoothly shift to a targeted posture given in FIG. 5, without shifting from the special posture to an untargeted posture given in FIG. 6.

On the other hand, even where the arm 2 assumes the special posture given in FIG. 4 during the movement of the hand unit 3 in a drawing direction, torque is supplied to the wrist rotation shaft 6e in a clockwise direction given in FIG. 1 (a direction to shift to a targeted posture). Therefore, the arm 2 is able to smoothly shift to a targeted posture, without shifting from the special posture to an untargeted posture.

In other words, according to the frog-leg-arm robot R of the present embodiment and the method for controlling the robot, even where the arm 2 assumes the special posture, the arm 2 always shifts to a targeted posture, without randomly shifting to an untargeted posture. Thus, it is possible to eliminate the singular point of control.

Furthermore, according to the frog-leg-arm robot of the present embodiment and the method for controlling the robot, torque is supplied to the wrist rotation shaft 6e only by electrical control not by mechanical control which depends on installation accuracy and configuration accuracy.

Therefore, even if there exists any change in operation environment, the amount of torque can be increased/decreased only by controlling electrical instructions without exchanging mechanical auxiliary device (spring member) such as a leaf spring. Therefore, the robot can be smoothly operated in the neighborhood of a singular point.

Still furthermore, since there is no need for further providing link members, the frog-leg-arm robot whose structure is simple is able to eliminate the singular point.

Furthermore, as compared with the case where an air cylinder is used, electric torque supply device such as an electric motor can be used to stably generate a desired torque without substantially depending on an electrical wiring state. A power source which is the same as that of the driving motor can be used, thereby eliminated the necessity for providing a separate mechanism such as an air supply source. Since there is no need for using long components such as a rack and pinion and an air cylinder, dimensional matters are not strictly restricted.

As described so far, in a posture (the special posture given in FIG. 4) which is conventionally taken as a singular point, torque is supplied by the electrically controllable torque motor 10 to the wrist rotation shaft 6e in a direction to shift to a targeted posture, thus it becomes possible to practically eliminate the singular point of control in the frog-leg-arm robot.

Furthermore, in the frog-leg-arm robot of the present embodiment and the control method thereof, since no mechanical mechanism (such as chains and sprockets) is provided for supplying torque to the wrist rotation shaft 6e, it is possible to simplify the constitution of the device. Due to the above-described reason, sliding components of the structure can be decreased in number to suppress the occurrence of dust from the device. Therefore, the frog-leg-arm robot of the present embodiment and the control method thereof can be appropriately used inside a clean room.

Only for eliminating the singular point of control, torque may be supplied to the wrist rotation shaft 6e only in a special posture. However, in the frog-leg-arm robot of the present embodiment and the control method thereof, torque is constantly supplied to the wrist rotation shaft 6e.

Therefore, in the frog-leg-arm robot of the present embodiment and the control method thereof, excessive restrictions are constantly given to the arm 2. Thereby, it is possible to suppress vibrations resulting from a difference in installation accuracy or configuration accuracy of the arm 2 or the hand unit 3. As a result, the hand unit 3 can be improved in positional accuracy.

Excessive restrictions are constantly given to the arm 2, which requires a greater increase in the output of the driving motors 51, 52 than conventionally required. However, where there is a difficulty in increasing the output of the driving motors 51, 52 more than conventionally required, torque may be supplied to the wrist rotation shaft 6e only in the special posture.

Furthermore, in the frog-leg-arm robot of the present embodiment and the control method thereof, the torque supplied to the wrist rotation shaft 6e by the torque motor 10 is set to be smaller than the torque supplied to the shoulder rotation shafts 6a, 6c by the driving motors 51, 52. Therefore, even during the supply of torque to the wrist rotation shaft 6e, the driving motors 51, 52 are used to supply torque to the shoulder rotation shafts 6a, 6c, it thus becomes possible to smoothly operate the arm 2 and the hand unit 3.

### Second Embodiment

Next, a description will be given for a second embodiment of the present invention. In the present embodiment, parts the same parts as those of the first embodiment will be omitted or simplified in the description.

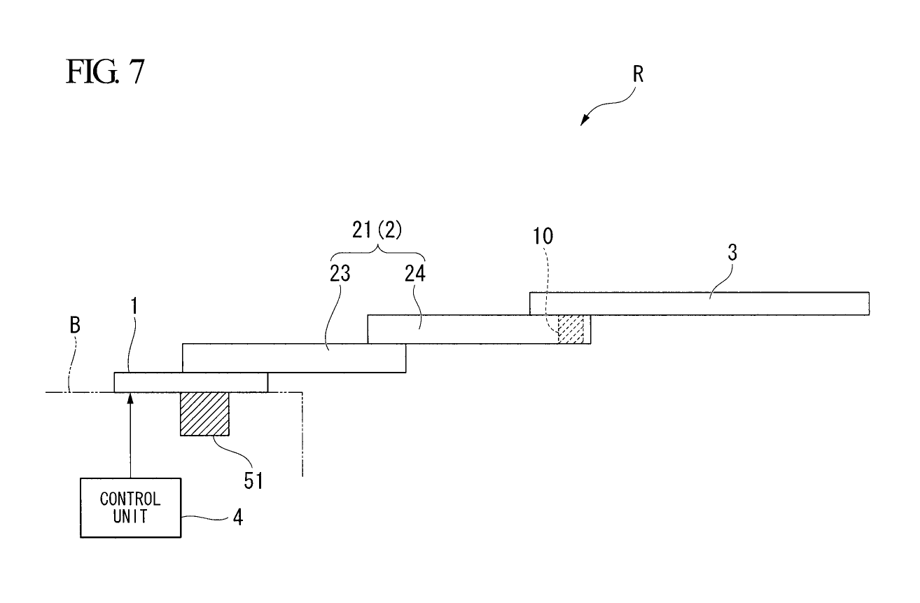

FIG. 7 is a side elevational view showing a schematic view of the frog-leg-arm robot of the present embodiment. As shown in this drawing, a torque motor 10 is accommodated inside a forearm 24 in the frog-leg-arm robot of the present embodiment.

According to the above-described frog-leg-arm robot of the present embodiment, since the torque motor 10 is accommodated inside the forearm 24, no member is projected outside the frog-leg-arm robot. Therefore, there is no need to secure a space for moving the torque motor outside the frog-leg-arm robot, by which the frog-leg-arm robot of the present embodiment can be mounted on a similar size space where a conventional frog-leg-arm robot is mounted.

It is noted that the torque motor 10 is not necessarily arranged inside the forearm 24. For example, where the torque motor 10 is connected to a wrist rotation shaft 6f, the torque motor 10 is arranged inside a forearm 26 in a state of being accommodated therein. Furthermore, where the torque motor 10 is connected to an elbow rotation shaft 6b, it is arranged inside one of either the forearm 24 and an upper arm 23 or inside both of them, in a state of being accommodated therein. Still furthermore, where the torque motor 10 is connected to an elbow rotation shaft 6d, it is arranged inside one of either the forearm 26 and an upper arm 25 or inside both of them in a state of being accommodated therein.

### Third Embodiment

Next, a description will be given for a third embodiment of the present invention. In the present embodiment, the same parts as those of the first embodiment will be omitted or simplified in the description.

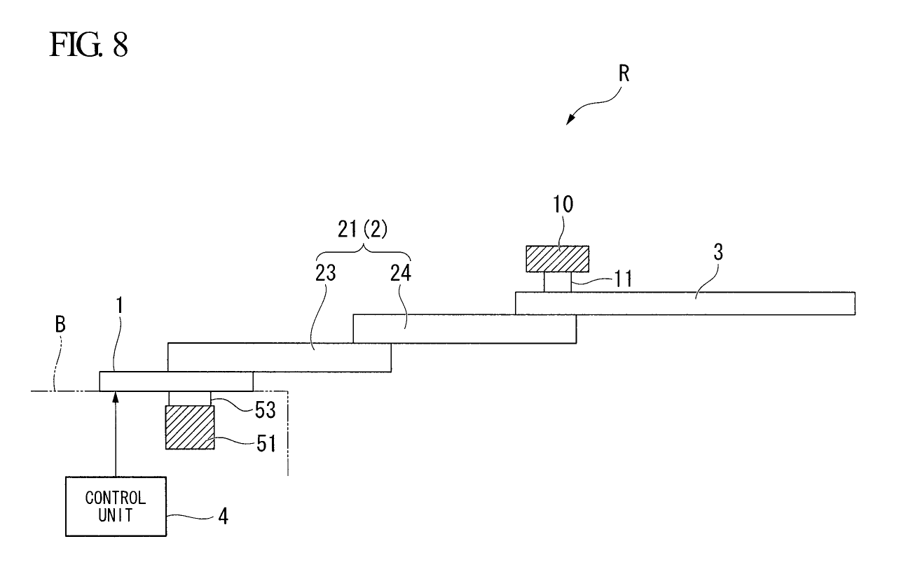

FIG. 8 is a side elevational view showing a brief constitution of a frog-leg-arm robot R, which is one embodiment of the present invention. As shown in this drawing, in the frog-leg-arm robot R of the present embodiment, a torque motor 10 is connected via a reduction gear 11 to a wrist rotation shaft 6e connecting a forearm 24 of a first arm 21 with a hand unit 3. Furthermore, a driving motor 51 is connected via a reduction gear 53 to a shoulder rotation shaft 6a, and a driving motor 52 is connected via the other reduction gear (not illustrated) to a shoulder rotation shaft 6c. The reduction rate of the reduction gear 53 is equal to that of the other reduction gear.

The torque motor 10 supplies the torque based on a torque control signal input from a control unit 4 to the wrist rotation shaft 6e in a direction along the horizontal surface. Furthermore, the torque motor 10 rotates at a rotational speed based on a rotational-speed control signal input from the control unit 4. A servo-type torque motor is favorably used as the torque motor 10 of the present embodiment.

In the frog-leg-arm robot R of the present embodiment, a rotational-speed control signal for controlling the rotational speed of the torque motor 10 is generated as operation instructing information of the torque motor 10 at a calculation processing unit 41. Furthermore, a storage unit 42 stores a calculation formula for calculating the rotational speed of the wrist rotation shaft 6e from control values of the driving motors 51, 52 and the reduction ratio of the reduction gear 11.

Still furthermore, upon supply of torque to the wrist rotation shaft 6e by using the torque motor 10, the control unit 4 synchronizes the rotational speed of the torque motor 10 with the rotational speed of the wrist rotation shaft 6e which is rotated dependent on the driving force of the driving motors 51, 52.

During the movement of the hand unit 3, the control unit 4 controls the torque motor 10, thereby supplying constant torque to the wrist rotation shaft 6e in a direction to shift from the special posture given in FIG. 4 to a targeted posture.

Specifically, when the hand unit 3 is allowed to move in a push-out direction, the control unit 4 controls a torque control signal input into the torque motor 10, thereby supplying torque to the wrist rotation shaft 6e in a counterclockwise direction in FIG. 1. Furthermore, when the hand unit 3 is allowed to move in a drawing direction, the control unit 4 controls the torque control signal input into the torque motor 10, thereby supplying torque to the wrist rotation shaft 6e in a clockwise direction in FIG. 1.

According to the frog-leg-arm robot R of the present embodiment and the control method thereof, as described in the above-described first embodiment, even where the arm 2 assumes a special posture, it will not randomly shift to an untargeted posture but will always shift to the targeted posture. Thus, a singular point of control is eliminated.

Furthermore, in the frog-leg-arm robot of the present embodiment, when torque is supplied to the wrist rotation shaft 6e by the torque motor 10, the control unit 4 synchronizes the rotational speed of the torque motor 10 with the rotational speed of the wrist rotation shaft 6e which is rotated dependent on the driving force of the driving motors 51, 52. In the frog-leg-arm robot R of the present embodiment and the control method thereof, when the hand unit 3 is moved in a push-out direction or moved in a drawing direction, torque is constantly supplied by the torque motor 6 to the wrist rotation shaft 6e. Therefore, in the frog-leg-arm robot R of the present embodiment and the control method thereof, the rotational speed of the torque motor 10 is always synchronized with the rotational speed of the wrist rotation shaft 6e which is rotated dependent on the driving force of the driving motors 51, 52.

In the present embodiment, a description that “the rotational speed of the torque motor 10 is synchronized with the rotational speed of the wrist rotation shaft 6e which is rotated dependent on the driving force of the driving motors 51, 52” means that the rotational speed of the torque motor 10 imparted via the reduction gear 11 to the wrist rotation shaft 6e is in agreement with the rotational speed imparted to the wrist rotation shaft 6e via the arm 2 dependent on the driving force of the driving motors 51, 52.

Specifically, the control unit 4 calculates a rotational speed of the wrist rotation shaft 6e by using a calculation formula for calculating the rotational speed of the wrist rotation shaft 6e from control values stored at the storage unit 42 based on the control values of the driving motors 51, 52. Next, the control unit 4 generates a rotational-speed control signal based on the calculation result and the reduction ratio stored at the storage unit 42. Then, the thus generated rotational-speed control signal is input into the torque motor 10.

Hereinafter, one example which generates a rotational-speed control signal will be described using formulae. In the following, a description will be given for a method generating the rotational-speed control signal on passage through the above-described special posture. It is noted that in each of the above embodiments, a description has been given for the rotational speed of each motor or each rotation shaft in an absolute space. However, in the following, a description will be given for the rotational speed of each motor or each rotation shaft in a relative space.

In the following formulae, the upper arms 23, 25 and the forearms 24, 26 are all assumed to be equal in length, with the length being designated as L (m). Furthermore, the rotational speed of the shoulder rotation shafts 6a, 6c is depicted as ωₐ (rpm); the rotational speed of the wrist rotation shaft 6e, ωₜ (rpm); the rotational speed of the torque motor 10, ωₜₘ (rpm); the reduction ratio of the reduction gear 11, ηₜ; the maximum rotational speed of the torque motor 10, ωₜₘₘₐₓ (rpm), and a torque motor speed instruction, y (%).

First, when the speed instruction input into the driving motors 51, 52 on passage through a special posture is depicted as V (m/min), the speed instruction V (control value to the driving motor) is expressed by the formula (1) given below.

(Formula 1)

V≈2Lωₐ·2π (1)

Therefore, the rotational speed ωₐ of the shoulder rotation shafts 6a, 6c is expressed in the formula (2) given below.

(Formula 2)

ωₐ≈V/4Lπ (2)

In this instance, the rotational speed ωₐ of the shoulder rotation shafts 6a, 6c should be synchronized in principle with the rotational speed ωₜ of the wrist rotation shaft 6e. Therefore, with the reduction ratio ηₜ taken into account, the rotational speed ωₐ of the shoulder rotation shafts 6a, 6c is expressed by the formula (3) given below.

(Formula 3)

ωₐ=ωₜₘ/ηₜ (3)

Therefore, the rotational speed ωₜₘ of the torque motor 10 can be expressed in the formula (4) given below. Furthermore, the above formula (2) is substituted for the formula (4) given below to obtain the formula (5) given below.

(Formula 4)

ωₜₘ=ωₐ·ηₜ (4)

(Formula 5)

ωₜₘ=V/4lπ·ηₜ (5)

The torque motor speed instruction y, that is, a rotational-speed control signal, is expressed as a ratio with respect to a maximum rotational speed of the torque motor 10. Therefore, it can be expressed in the formula (6) given below.

(Formula 6)

y=ωₜₘ100/ωₜₘₘₐₓ (6)

The above formula (5) is substituted for the formula (6), by which the torque motor speed instruction y, which is a rotational-speed control signal to be determined, is expressed in the formula (7) given below.

(Formula 7)

y=V·100·(ηₜ/4Lπωₜₘₘₐₓ) (7)

The above description is a theoretical formula given in a coordinate system on which the driving motors 51, 52 are mounted. However, since the torque motor 10 is connected to the driving motors 51, 52 via the above-described arm mechanism, the torque motor 10 is mounted on a space which relatively rotates in terms of the driving motors 51, 52. Therefore, with mechanical matters taken into account, an instruction for the rotational speed of the torque motor 10 is practically given by as much as twice.

According to the above-described frog-leg-arm robot of the present embodiment and the control method thereof, upon supply of torque to the wrist rotation shaft 6e, the rotational speed of the torque motor 10 is synchronized with the rotational speed of the wrist rotation shaft 6e which is rotated dependent on the driving force of the driving motors 51, 52. Specifically, the rotational speed of the torque motor 10 imparted via the reduction gear 11 to the wrist rotation shaft 6e is in agreement with the rotational speed imparted via the arm 2 to the wrist rotation shaft 6e dependent on the driving force of the driving motors 51, 52. Therefore, no loads are applied to the torque motor 10 or the wrist rotation shaft 6e, if not needed. As a result, it is possible to prevent the occurrence of vibrations to the frog-leg-arm robot R.

As a result, according to the frog-leg-arm robot of the present embodiment and the control method thereof, it is possible to prevent the occurrence of vibrations resulting from the fact that the rotational speed of the torque motor 10 is not synchronized with the rotational speed of the wrist rotation shaft 6e in the frog-leg-arm robot where the torque motor 10 is mounted on the wrist rotation shaft 6e.

Furthermore, in the frog-leg-arm robot of the present embodiment and the control method thereof, a torque control signal is input from the control unit 4 into the torque motor 10 so that torque is supplied in a direction to shift to a targeted posture including a case where the robot assumes a special posture.

Therefore, in a posture (the special posture given in FIG. 4) which is conventionally taken as a singular point, torque is supplied to the wrist rotation shaft 6e in a direction to shift to a targeted posture. As a result, it is possible to eliminate the singular point of control in the frog-leg-arm robot.

### EXAMPLE

A description will be given for a specific example of the third embodiment of the present invention.

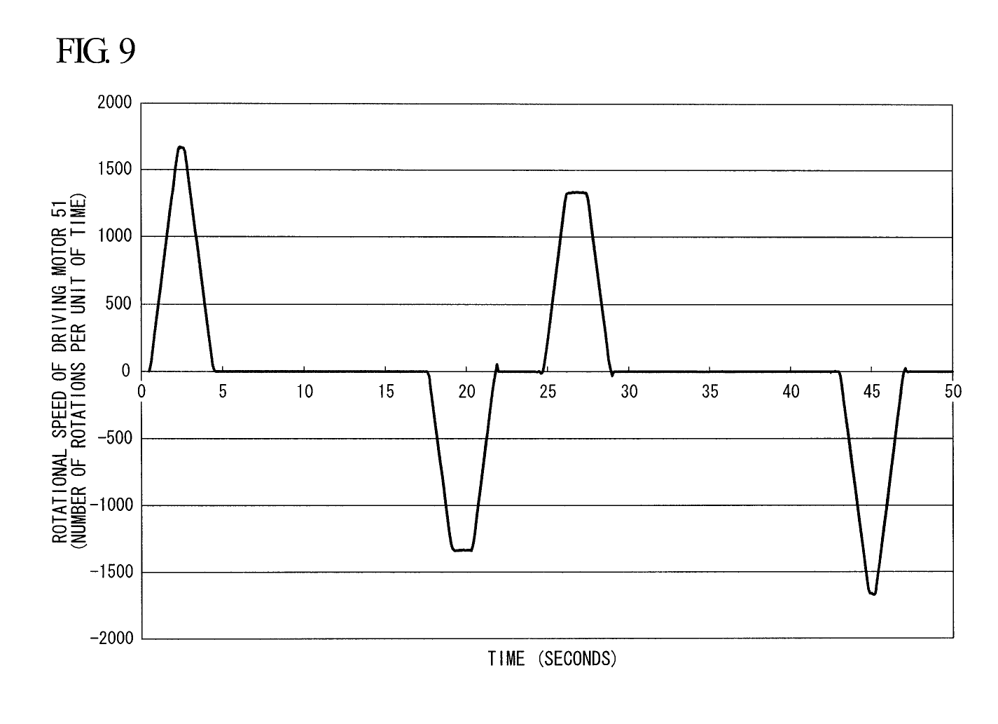

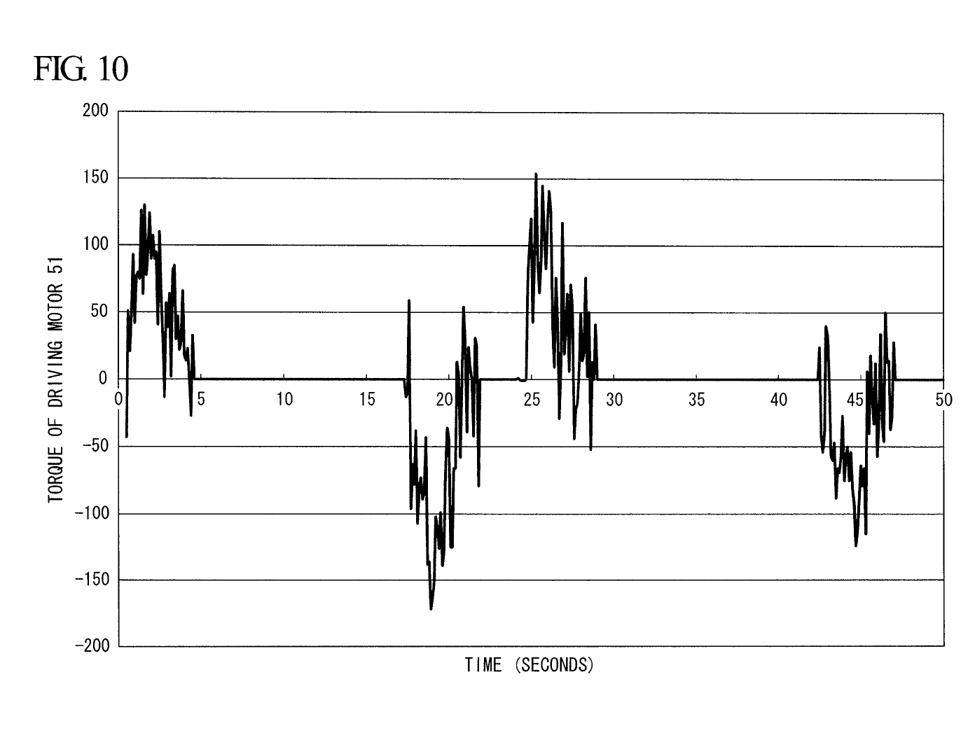

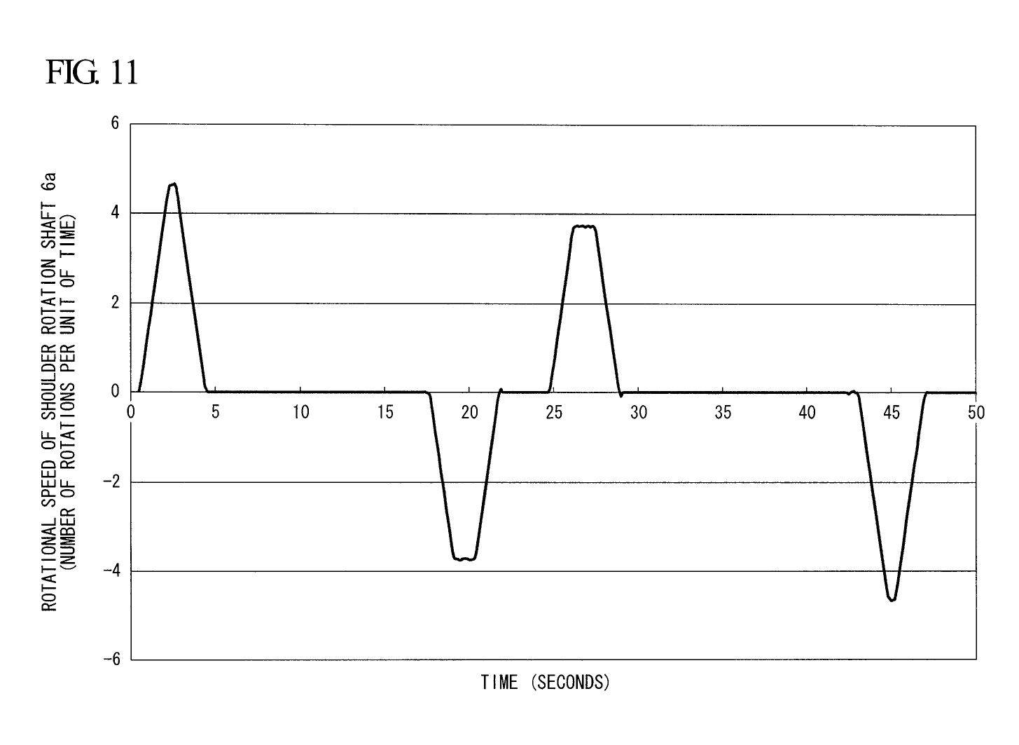

FIG. 9 is a graph showing the over-time change in rotational speed of the driving motor 51, FIG. 10 is a graph showing the over-time change in torque generated by the driving motor 51, and FIG. 11 is a graph showing the over-time change in rotational speed of the shoulder rotation shaft 6a to which the driving motor 51 is connected.

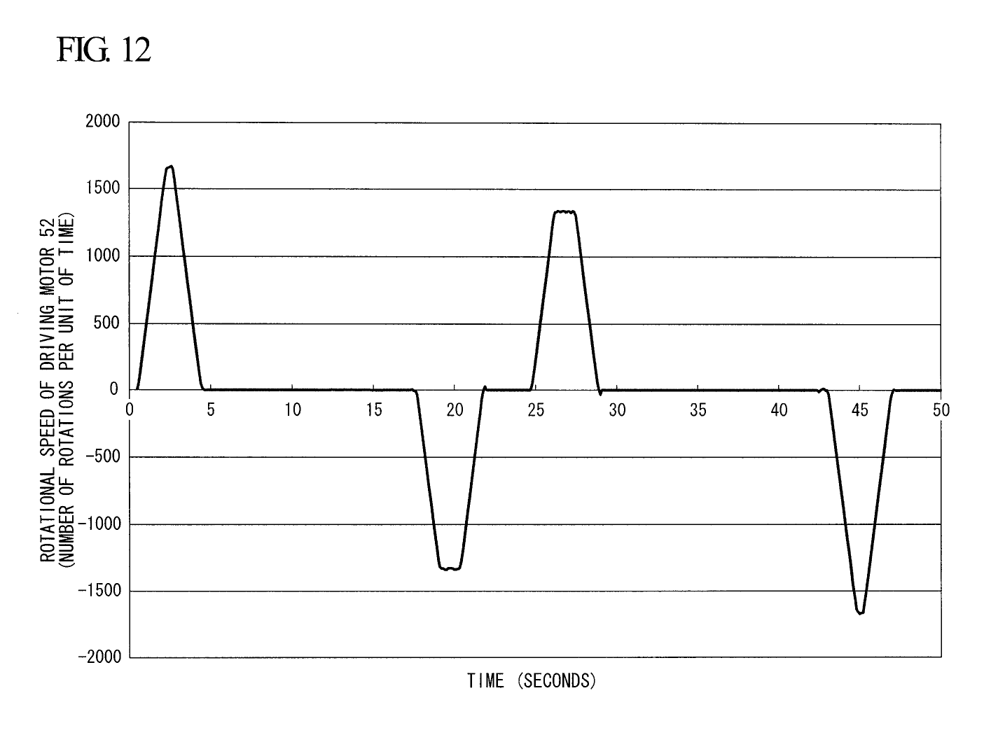

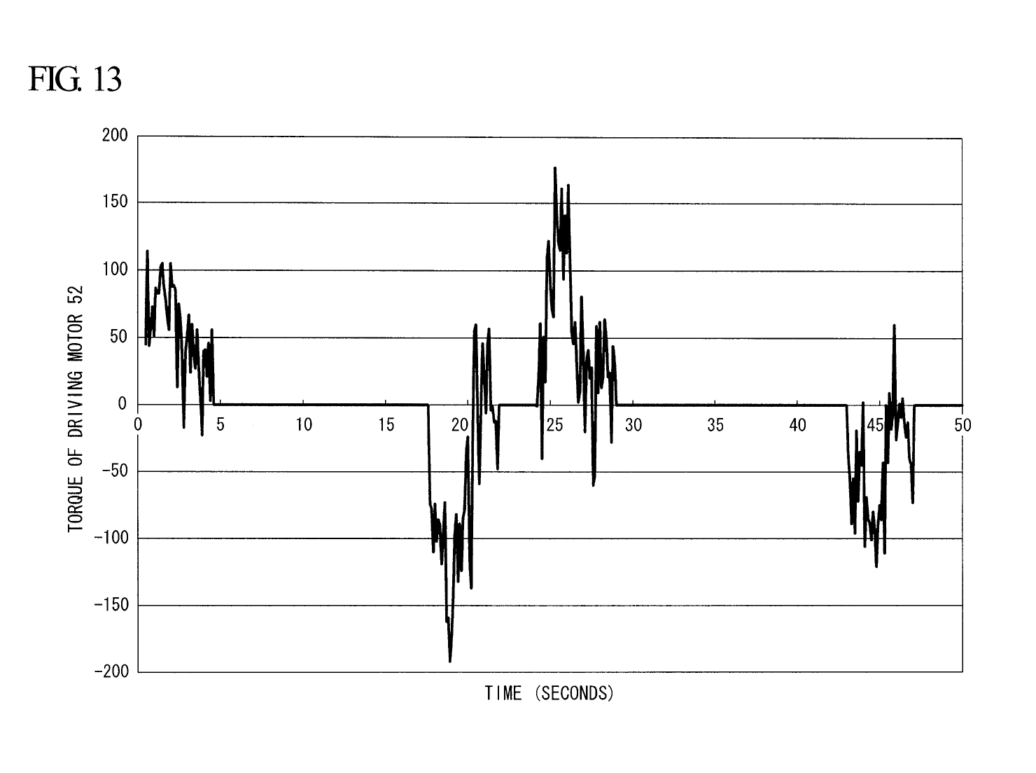

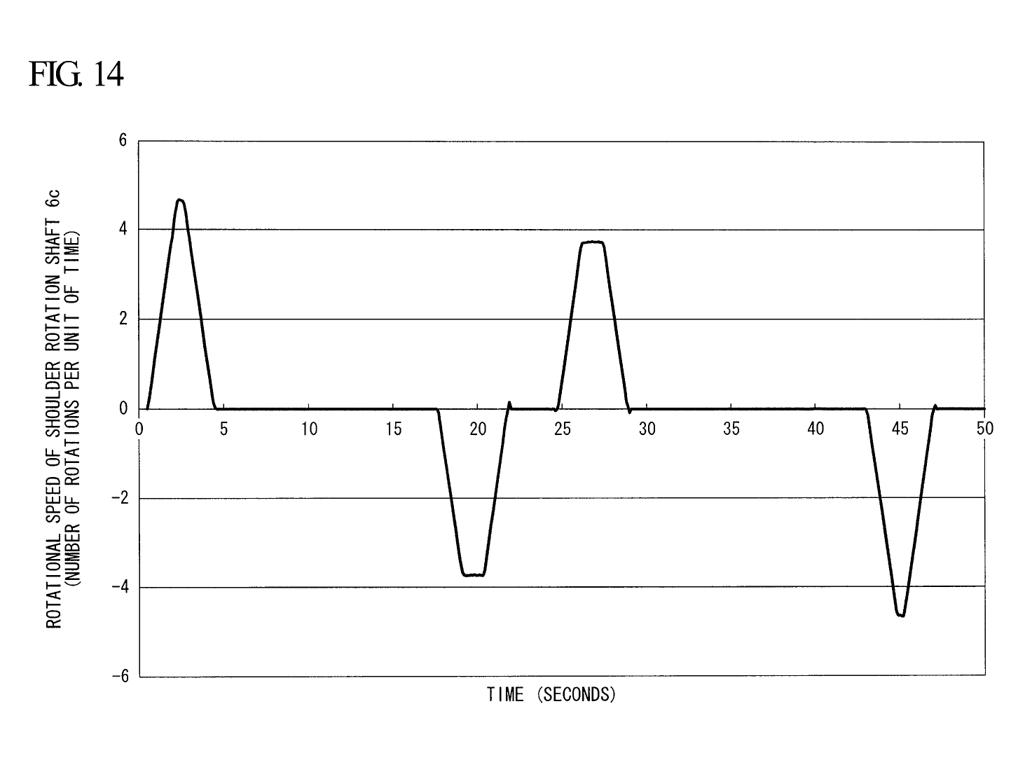

FIG. 12 is a graph showing the over-time change in rotational speed of the driving motor 52, FIG. 13 is a graph showing the over-time change in torque generated by the driving motor 52, and FIG. 14 is a graph showing the over-time change in rotational speed of the shoulder rotation shaft 6c to which the driving motor 52 is connected.

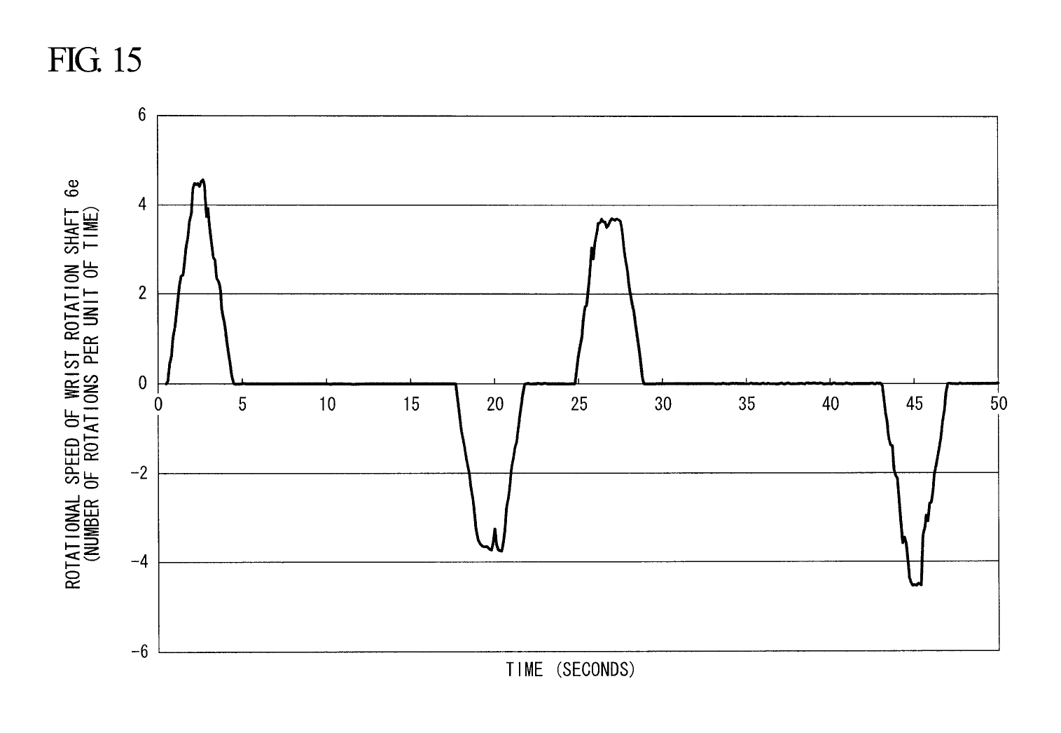

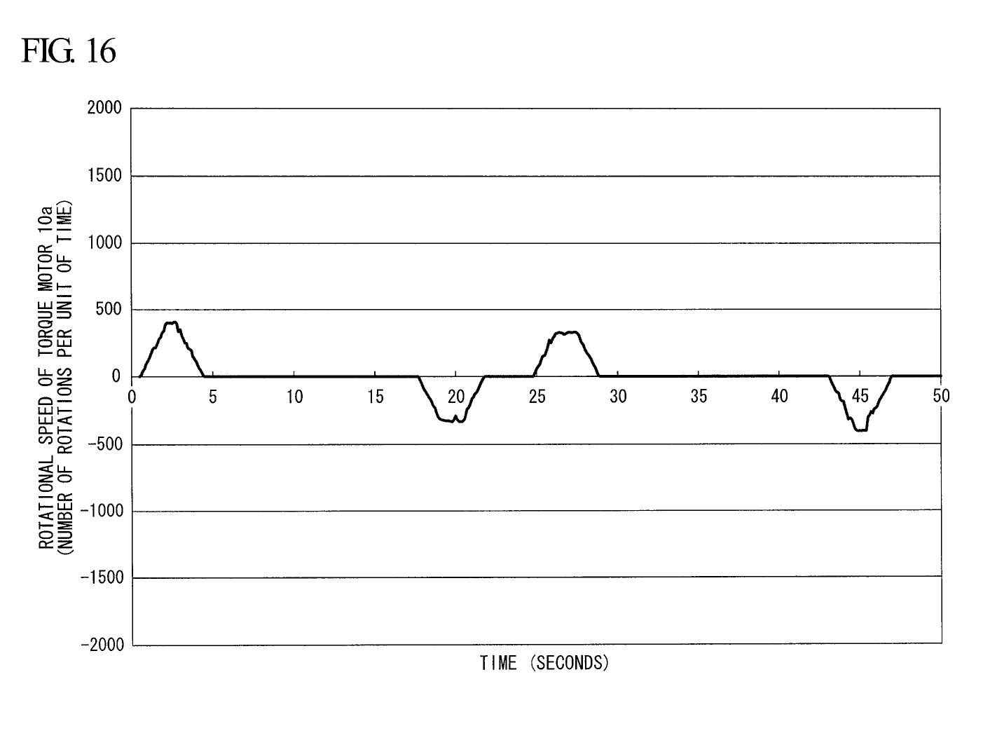

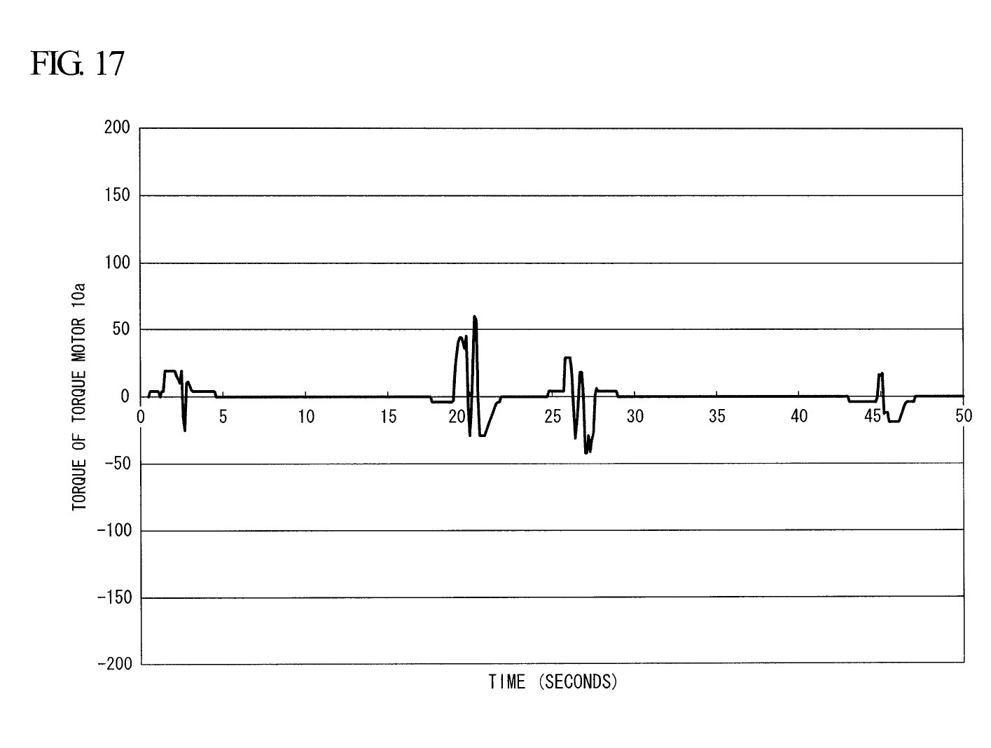

FIG. 15 is a graph showing the over-time change in rotational speed of the wrist rotation shaft 6e to which the torque motor 10 is connected. FIG. 16 is a graph showing the over-time change in rotational speed of the torque motor 10, and FIG. 17 is a graph showing the over-time change in torque generated by the torque motor 10.

It is noted that all the graphs show the results obtained by examining the change in the respective rotational speeds, with the same starting point kept on the same temporal axis.

When the graph of FIG. 9 is compared with the graph of FIG. 11, since the driving motor 51 is connected via the reduction gear 53 to the shoulder rotation shaft 6a, the rotational speed of the shoulder rotation shaft 6a is reduced more greatly than the rotational speed of the driving motor 51. Therefore, the magnitude of the rotational speed at any given temporal point of the shoulder rotation shaft 6a is not in agreement with the magnitude of the rotational speed at the same temporal point of the driving motor 51. However, the rotational speed of the shoulder rotation shaft 6a changes with the lapse of time, as with the change in rotational speed of the driving motor 51.

In a similar manner, when the graph of FIG. 12 is compared with the graph of FIG. 14, since the driving motor 52 is connected to the shoulder rotation shaft 6c via a reduction gear (not illustrated) equal in reduction ratio to the reduction gear 53, the rotational speed of the shoulder rotation shaft 6c is reduced more greatly than the rotational speed of the driving motor 52. Therefore, the magnitude of the rotational speed at any given temporal point of the shoulder rotation shaft 6c is not in agreement with the magnitude of the rotational speed at the same temporal point of the driving motor 52. However, the rotational speed of the shoulder rotation shaft 6c changes with the lapse of time, as with the change in rotational speed of the driving motor 52.

When the graph of FIG. 11 is compared with the graph of FIG. 14, since the driving motor 51 and the driving motor 52 are driven in synchronization, the rotational speed of the shoulder rotation shaft 6a changes with the lapse of time substantially in agreement with the rotational speed of the shoulder rotation shaft 6c.

When the graph of FIG. 11 is compared with the graph of FIG. 15, since the upper arm 23 is equal in length to the forearm 24 in the arm 21 of the present embodiment, the rotational speed of the wrist rotation shaft 6e which is linked with the shoulder rotation shaft 6a via the upper arm 23 and the forearm 24 changes with the lapse of time substantially in agreement with the rotational speed of the shoulder rotation shaft 6a to which the driving motor 51 is connected.

When the graph of FIG. 14 is compared with the graph of FIG. 15, since the upper arm 25 is equal in length to the forearm 26 in the arm 22 of the present embodiment, the rotational speed of the wrist rotation shaft 6e which is linked with the shoulder rotation shaft 6c via the upper arm 25, the forearm 26 and the synchronization gears 71, 72 changes with the lapse of time substantially in agreement with the rotational speed of the shoulder rotation shaft 6c to which the driving motor 52 is connected.

Therefore, the rotational speed of the shoulder rotation shaft 6a or the rotational speed of the shoulder rotation shaft 6c may be regarded as the rotational speed of the wrist rotation shaft 6e.

When the graph of FIG. 15 is compared with the graph of FIG. 16, since the torque motor 10 is connected to the wrist rotation shaft 6e via the reduction gear 11, the rotational speed of the wrist rotation shaft 6e is reduced more greatly than the rotational speed of the torque motor 10. Therefore, the magnitude of the rotational speed at any given temporal point of the wrist rotation shaft 6e is not in agreement with the magnitude of the rotational speed at the same temporal point of the torque motor 10. However, the rotational speed of the wrist rotation shaft 6e changes with the lapse of time, as with the change in rotational speed of the torque motor 10.

When the graph of FIG. 10 is compared with the graph of FIG. 17, the torque generated by the torque motor 10 is smaller than the torque generated by the driving motor 51. Furthermore, when the graph of FIG. 13 is compared with the graph of FIG. 17, the torque generated by the torque motor 10 is smaller than the torque generated by the driving motor 52.

The control unit 4 of the present embodiment electrically controls the torque motor 10, thereby synchronizing the rotational speed of the torque motor 10 with the rotational speed of the wrist rotation shaft 6e which is rotated dependent on the driving force of the driving motors 51, 52. It is, therefore, apparent that no load is applied to the torque motor 10 or the wrist rotation shaft 6e, if not needed, by controlling the torque motor 10. In fact, it has been confirmed that the frog-leg-arm robot R of the above example is less likely to cause vibrations.

It has been also confirmed that the torque motor 10 of the present embodiment is sufficiently functional although smaller in output than the driving motors 51, 52.

A description has been so far given for preferred embodiments of the frog-leg-arm robot of the present invention and the control method thereof with reference to the drawings. It is obvious that the present invention may not be limited to the above embodiments. Various configurations, combinations of individual constituents in the above embodiments are only examples and may be modified in various ways within a scope not departing from the gist of the present invention.

For example, in each of the first, the second and the third embodiments, the torque motor 10 is connected to the wrist rotation shaft 6e, thereby supplying torque only to the wrist rotation shaft 6e. However, the present invention may not be limited thereto. Similar effects can be obtained, if the torque motor 10 is connected to one of the elbow rotation shafts 6b, 6d and wrist rotation shafts 6e, 6f.

Furthermore, the flog-leg-arm robot may be provided with a plurality of the torque motors 10. The torque motor may be connected to two or more of the elbow rotation shafts 6b, 6d and the wrist rotation shafts 6e, 6f. However, where a plurality of the torque motors are mounted, the arm 2 is more excessively restrained, which may affect smooth operations of the arm 2 and the hand unit 3. It is, therefore, desirable to provide only one torque motor. Even in this instance, the rotational speed of the torque motor is synchronized with the rotational speed of the rotation shaft dependent on the driving force of the driving motor.

In each of the above-described embodiments, a description has been given for a constitution in which the arm 2 is swung along a horizontal surface. However, the present invention may not be limited thereto but may be applicable to a frog-leg-arm robot in which the arm 2 is swung along a planar surface (a reference planar surface) different in angle from the horizontal surface and to the control method thereof.

In each of the above-described embodiments, the first arm 21 is coupled via the shoulder rotation shaft 6a to the main body 1 and the second arm 22 is also coupled via the shoulder rotation shaft 6c to the main body 1. Specifically, there are provided two first rotation shafts of the present invention. However, the present invention may not be limited thereto. The first arm 21 and the second arm 22 may both be coupled via a common shoulder rotation shaft to the main body 1, and the first arm 21 and the second arm 22 may be rotated by each other in the opposite direction. In other words, the robot may be provided with only one rotation shaft of the present invention.

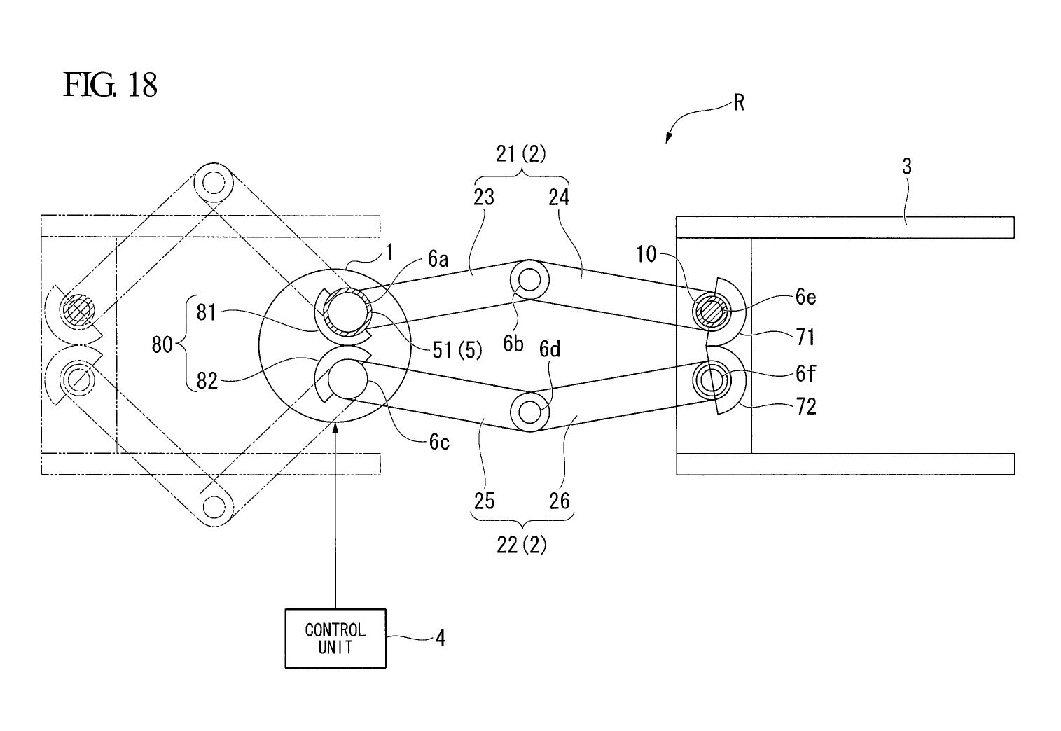

In each of the above-described embodiments, the driving device 5 is provided with a driving motor 51 for swinging the upper arm 23 via the shoulder rotation shaft 6a and a driving motor 52 for swinging the upper arm 25 via the shoulder rotation shaft 6c. Then, the shoulder rotation shaft 6a driven by the driving motor 51 is rotated in synchronization with the shoulder rotation shaft 6c driven by the driving motor 52, thus it becomes possible to move the hand unit 3 linearly. Incidentally, as shown in FIG. 18, the driving device 5 may be provided with the driving motor 51 for swinging the upper arm 23 via the shoulder rotation shaft 6a and a driving-force transfer mechanism 80 mounted between the shoulder rotation shaft 6a and the shoulder rotation shaft 6c to transfer the driving force of the driving motor 51 to the upper arm 25 via the shoulder rotation shaft 6a and the shoulder rotation shaft 6c, thereby swinging the upper arm 25. The driving-force transfer mechanism 80 is composed of two synchronization gears 81, 82 and similar in structure to the synchronization gears 71, 72 of the first embodiment. Then, the shoulder rotation shaft 6a driven by the driving motor 51 is rotated in synchronization with the shoulder rotation shaft 6c driven by the driving motor 51 via the driving-force transfer mechanism 80, thus it becomes possible to move the hand unit 3.

In the above-described third embodiment, the torque motor 10 is connected via the reduction gear 11 to the wrist rotation shaft 6e. However, the present invention may not be limited thereto. The torque motor 10 may be directly connected to the wrist rotation shaft 6e. In this instance, there is no need to take a reduction ratio into account. The rotational speed of the torque motor 10 is made in agreement with the rotational speed of the wrist rotation shaft 6e dependent on the driving force of the driving motors 51, 52, thereby preventing unnecessary loads from being applied to the torque motor 10 or the wrist rotation shaft 6e. As a result, it is possible to prevent the occurrence of vibrations to the frog-leg-arm robot R.

### INDUSTRIAL APPLICABILITY

The present invention relates to a frog-leg-arm robot which is provided with: a main body; a driving device mounted on the main body; a first upper arm, one end of the first upper arm being coupled to the main body via a first rotation shaft rotated by the driving device and the first upper arm being able to swing along a reference planar surface; a second upper arm, one end of the second upper arm being coupled to the main body via the first rotation shaft or the other first rotation shaft rotated and driven by the driving device and the second upper arm being able to swing along the reference planar surface; a first forearm, one end of the first forearm being supported on the other end of the first upper arm so as to rotate via a second rotation shaft and the first forearm being able to swing along the reference planar surface; a second forearm, one end of the second forearm being supported on the other end of the second upper arm so as to rotate via a third rotation shaft and the second forearm being able to swing along the reference planar surface; a hand unit which is supported on the other end of the first forearm so as to rotate via a fourth rotation shaft and also supported on the other end of the second forearm so as to rotate via a fifth rotation shaft; a synchronization device for synchronically rotating the fourth rotation shaft and the fifth rotation shaft in the opposite direction; a torque motor which is connected to at least one of the second rotation shaft, the third rotation shaft, the fourth rotation shaft and the fifth rotation shaft to supply torque to the rotation shaft to which the torque motor itself is connected; and a control unit which electrically controls the torque motor in such a manner that when the first upper arm, the second upper arm, the first forearm and the second forearm are able to shift from the current posture to any plurality of postures including a targeted posture by the driving force of the driving device, the torque is supplied to the rotation shaft in a direction which each of the arms is able to shift to the targeted posture.

According to the present invention, it is possible to practically eliminate a singular point of control in the frog-leg-arm robot.

1. A frog-leg-arm robot comprising: a main body;
a driving device mounted on the main body;
a first upper arm, one end of the first upper arm being coupled to the main body via a first rotation shaft rotated by the driving device and the first upper arm being able to swing along a reference planar surface;
a second upper arm, one end of the second upper arm being coupled to the main body via the first rotation shaft or the other first rotation shaft rotated and driven by the driving device and the second upper arm being able to swing along the reference planar surface;
a first forearm, one end of the first forearm being supported on the other end of the first upper arm so as to rotate via a second rotation shaft and the first forearm being able to swing along the reference planar surface;
a second forearm, one end of the second forearm being supported on the other end of the second upper arm so as to rotate via a third rotation shaft and the second forearm being able to swing along the reference planar surface;
a hand unit which is supported on the other end of the first forearm so as to rotate via a fourth rotation shaft and also supported on the other end of the second forearm so as to rotate via a fifth rotation shaft;
synchronization device for synchronically rotating the fourth rotation shaft and the fifth rotation shaft in the opposite direction;
a torque motor which is connected to at least one of the second rotation shaft, the third rotation shaft, the fourth rotation shaft and the fifth rotation shaft to supply torque to the rotation shaft to which the torque motor itself is connected; and
a control unit which electrically controls the torque motor in such a manner that when the first upper arm, the second upper arm, the first forearm and the second forearm are able to shift from the current posture to any plurality of postures including a targeted posture by the driving force of the driving device, the torque is supplied to the rotation shaft in a direction which each of the arms is able to shift to the targeted posture.

2. The frog-leg-arm robot according to claim 1, wherein
the torque supplied by the torque motor to at least one of the second rotation shaft, the third rotation shaft, the fourth rotation shaft and the fifth rotation shaft is smaller than the torque supplied by the driving device to the first rotation shaft.

3. The frog-leg-arm robot according to claim 1, wherein
the control unit controls the torque motor so that the torque is constantly supplied in the same direction during the movement of the hand unit to a predetermined one direction.

4. The frog-leg-arm robot according to claim 1, wherein
the torque motor is accommodated inside at least one of the first upper arm, the second upper arm, the first forearm and the second forearm.

5. The frog-leg-arm robot according to claim 1, wherein
the torque motor supplies torque based on a torque control signal to a rotation shaft to which the torque motor itself is connected and also rotates the rotation shaft at a rotational speed based on a rotational-speed control signal, and
the control unit inputs the torque control signal into the torque motor and also inputs the rotational-speed control signal into the torque motor so that the rotational speed of the torque motor is synchronized with the rotational speed of the rotation shaft which is rotated dependent on the driving force of the driving device.

6. The frog-leg-arm robot according to claim 5, wherein
the control unit calculates a rotational speed of the rotation shaft to which the torque motor is connected based on a control value of the driving device.

7. The frog-leg-arm robot according to claim 5, wherein the robot is further provided with a reduction gear interposed between the torque motor and the rotation shaft to reduce the rotational speed of the torque motor and transfer the rotation of the torque motor to the rotation shaft, wherein the control unit generates the rotational-speed control signal based on a reduction ratio of the reduction gear and rotational speed of the rotation shaft reduced by the reduction gear.

8. The frog-leg-arm robot according to claim 1, wherein
the frog-leg-arm robot is only one torque motor.

9. The frog-leg-arm robot according to claim 1, wherein
the driving device is provided with a first driving motor which swings the first upper arm via the first rotation shaft and a second driving motor which swings the second upper arm via the other first rotation shaft.

10. The frog-leg-arm robot according to claim 1, wherein
the driving device is provided with a driving motor for swinging the first upper arm via the first rotation shaft and a driving-force transfer mechanism mounted between the first rotation shaft and the second rotation shaft to swing the second upper arm by transferring the driving force of the driving motor via the first and the second rotation shafts to the second upper arm.

11. A method for controlling a frog-leg-arm robot which is provided with: a main body; a driving device mounted on the main body; a first upper arm, one end of the first upper arm being coupled to the main body via a first rotation shaft rotated by the driving device and the first upper arm being able to swing along a reference planar surface; a second upper arm, one end of the second upper arm being coupled to the main body via the first rotation shaft or the other first rotation shaft rotated and driven by the driving device and the second upper arm being able to swing along the reference planar surface; a first forearm, one end of the first forearm being supported on the other end of the first upper arm so as to rotate via a second rotation shaft and the first forearm being able to swing along the reference planar surface; a second forearm, one end of the second forearm being supported on the other end of the second upper arm so as to rotate via a third rotation shaft and the second forearm being able to swing along the reference planar surface; a hand unit which is supported on the other end of the first forearm so as to rotate via a fourth rotation shaft and also supported on the other end of the second forearm so as to rotate via a fifth rotation shaft; a synchronization device for synchronically rotating the fourth rotation shaft and the fifth rotation shaft in the opposite direction; and a torque motor which is connected to at least one of the second rotation shaft, the third rotation shaft, the fourth rotation shaft and the fifth rotation shaft to supply torque to the rotation shaft to which the torque motor itself is connected, and
the method for controlling the frog-leg-arm robot comprising a step of electrically controlling the torque motor so that the torque is supplied to the rotation shaft in a direction in which each of the arms is able to shift to the targeted posture when the first upper arm, the second upper arm, the first forearm and the second forearm are able to shift from the present posture to any plurality of postures including a targeted posture by the driving force of the driving device.

12. The method for controlling the frog-leg-arm robot according to claim 11, wherein the torque supplied by the torque motor to at least one of the second rotation shaft, the third rotation shaft, the fourth rotation shaft and the fifth rotation shaft is smaller than the torque supplied by the driving device to the first rotation shaft.

13. The method for controlling the frog-leg-arm robot according to claim 11, wherein
the torque is constantly supplied in the same direction during the movement of the hand unit to a predetermined direction.

14. The method for controlling the frog-leg-arm robot according to claim 11, wherein
the torque motor supplies torque based on a torque control signal to the rotation shaft to which the torque motor itself is connected and also rotates the rotation shaft at a rotational speed based on a rotational-speed control signal, and
the torque control signal is input into the torque motor and the rotational-speed control signal is also input into the torque motor in such a manner that the rotational speed of the torque motor is synchronized with the rotational speed of the rotation shaft which is rotated by the driving force of the driving device.

15. The method for controlling the frog-leg-arm robot according to claim 14, wherein
the rotational speed of the rotation shaft to which the torque motor is connected is calculated based on a control value of the driving device.

16. The method for controlling the frog-leg-arm robot according to claim 14, wherein
the rotational-speed control signal is generated based on a reduction ratio of a reduction gear interposed between the torque motor and the rotation shaft to reduce the rotational speed of the torque motor and transfer the rotation of the torque motor to the rotation shaft and a rotational speed of the rotation shaft reduced by the reduction gear.

17. The method for controlling the frog-leg-arm robot according to claim 11, wherein
the torque is supplied to at least one of the second rotation shaft, the third rotation shaft, the fourth rotation shaft and the fifth rotation shaft.
